(19) United States
(12) Patent Application Publication
(10) Pub. No.: US 2003/0124304 A1
(43) Pub. Date: Jul. 3, 2003

(54) Vehicle energy absorbing element

(76) Inventors: Rajendran S. Michael, Granville, OH (US); Prakash Kolluri, Novi, MI (US)

Correspondence Address: OWENS CORNING, 2790 COLUMBUS ROAD, GRANVILLE, OH, 43023, US

(21) Appl. No.: 10/039,055

(22) Filed: Dec. 31, 2001

(51) Int. Cl. B32B 3/04

(52) U.S. Cl. 428/122; 428/174; 264/325

(57) ABSTRACT

An energy-absorbing element for a vehicle component is provided. The element is formed of a composite material comprising a combination or mixture of mineral fibers, such as glass fibers, and organic fibers, such as polypropylene fibers.

### CROSS REFERENCE TO RELATED APPLICATION

This application is related to patent application, U.S. Ser. No. ______(Attorney Docket No. 24970/24971) filed concurrently herewith, by Raj Michael, and entitled “TUNABLE OR ADJUSTABLE LINER FOR SELECTIVELY ABSORBING SOUND ENERGY AND RELATED METHODS,” the disclosure of which is incorporated herein by reference.

### TECHNICAL FIELD AND INDUSTRIAL APPLICABILITY OF THE INVENTION

The present invention relates to an energy-absorbing element for a vehicle as well as a trim panel/energy-absorbing element combination.

### BACKGROUND OF THE INVENTION

In a conventional vehicle, such as a passenger car, truck, minivan or the like, an A-pillar separates the windshield from the side door window. Passenger cars also contain B-pillars and rear-pillars. Other vehicles such as minivans may contain additional pillars. Currently, such vehicles have energy absorbing material positioned on the pillars so as to provide some protection to the vehicle driver and passengers from injury resulting from vehicle crashes. The energy absorbing material may comprise numerous types of foam (some reinforced with metal supports), cushions containing a fluid, honeycombed and other shaped collapsible structures, or molded plastic cartridges.

Recently, the United States government has enacted specific requirements relating to the protection of vehicle occupants during a crash and, more particularly, to the performance of impact absorbing materials and associated panels subjected to free motion head form (FMH) impact at approximately fifteen miles per hour. Previously developed impact absorbing material provided adequate impact protection under government standards. However, improved impact absorbing materials and associated panels are needed that satisfy the federal regulations, are less costly to manufacture, and are lighter weight.

### SUMMARY OF THE INVENTION

In accordance with the present invention, an impact-absorbing element or material adapted to be positioned adjacent to a vehicle component, such as a pillar, is provided. The element is formed of composite material comprising a mixture of mineral and organic fibers. The element functions to absorb a portion of the impact energy of an object, such as the head of a passenger in a vehicle, during a collision. This element is believed to be less costly to manufacture and less dense and/or lighter weight than prior art energy-absorbing elements.

In accordance with a first aspect of the present invention, an energy-absorbing element is provided which is capable of absorbing a portion of impact energy created during a collision. The energy-absorbing element comprises at least one layer of composite material comprising a mixture of mineral fibers and organic fibers.

Preferably, the composite material comprises a co-fiberized composite material.

The mineral fibers may comprise glass fibers, stone wool fibers or any other fibers formed from spinning molten inorganic material to form fibers.

The organic fibers may be formed from a material selected from the group consisting of polypropylene; polyphenylene sulfide; polyethylene terephthalate (PET); polyethylene; poly(α-olefin) copolymers; nylon 6; nylon 66; nylon 46; nylon 12; copolyamides; polycarbonate; copolymers of polycarbonate; polybutylene terephthalate (PBT); polypropylene terephthalate (PPT); polyphenylene ether (PPE); and blends thereof.

The layer may have a maximum thickness of from about 5 mm to about 50 mm. It may also have a density of from about 500 grams/m² to about 3000 grams/m².

The layer may comprise a sheath having a generally U- or V-shape in cross section, which is adapted to be positioned adjacent to a vehicle pillar. The sheath may also be formed having other cross sectional shapes, such as a C-shape, L-shape, or the like.

The composite material comprises mineral fibers in an amount from about 10% to about 90% by weight, based on the total weight of the composite material, and organic fibers in an amount from about 10% to about 90% by weight, based on the total weight of the composite material.

In accordance with a second aspect of the present invention, a method is provided for manufacturing an energy-absorbing sheath adapted to be positioned adjacent to a vehicle pillar. The method comprises the steps of: providing a composite material substrate including a mixture of mineral fibers and organic fibers; and forming the composite material substrate into the sheath.

The forming step may include the step of placing the substrate between a pair of opposing dies that together form an inner cavity when closed corresponding to the desired shape of the sheath. The substrate may be formed into a substantially U- or V-shaped sheath or a sheath having a shape that follows the contour of the corresponding inner metal section of the vehicle pillar. The sheath preferably has a density of from about 500 grams/m² to about 3000 grains/m².

In accordance with a third aspect of the present invention, a trim panel/sheath combination is provided which is adapted to be secured to a vehicle pillar. The combination comprises a polymeric trim panel; and a sheath formed of composite material comprising a mixture of mineral fibers and organic fibers.

The composite material may be comprised of a co-fiberized composite material.

The sheath may have a maximum thickness of from about 5 mm to about 50 mm. It may also have a density of from about 500 grams/m² to about 3000 grams/m².

The sheath may have a generally V-shape or other geometric shape in cross-section and is adapted to be positioned between the pillar and the trim panel.

The trim panel may have a density of from about 0.5 grams/cm³ to about 1.5 grams/cm³.

### BRIEF DESCRIPTION OF THE DRAWING FIGURES

FIG. 1 is a cross sectional view of a sheath and corresponding trim panel of the present invention coupled to a vehicle pillar;

FIG. 2 is an exploded view, partially broken away, of the sheath and corresponding trim panel of the present invention coupled to a vehicle pillar;

FIGS. 3A and 3B are partially schematic, partially cross-sectional views of the cold molding process used to form the sheath of the present invention;

FIG. 4 is a partially schematic, partially cross-sectional view in elevation of an apparatus for co-fiberizing glass fibers and fibers of a polymeric material to create a composite batt for use in forming the sheath of this invention; and

FIG. 5 illustrates test data corresponding to the Example.

### DETAILED DESCRIPTION AND PREFERRED EMBODIMENTS OF THE INVENTION

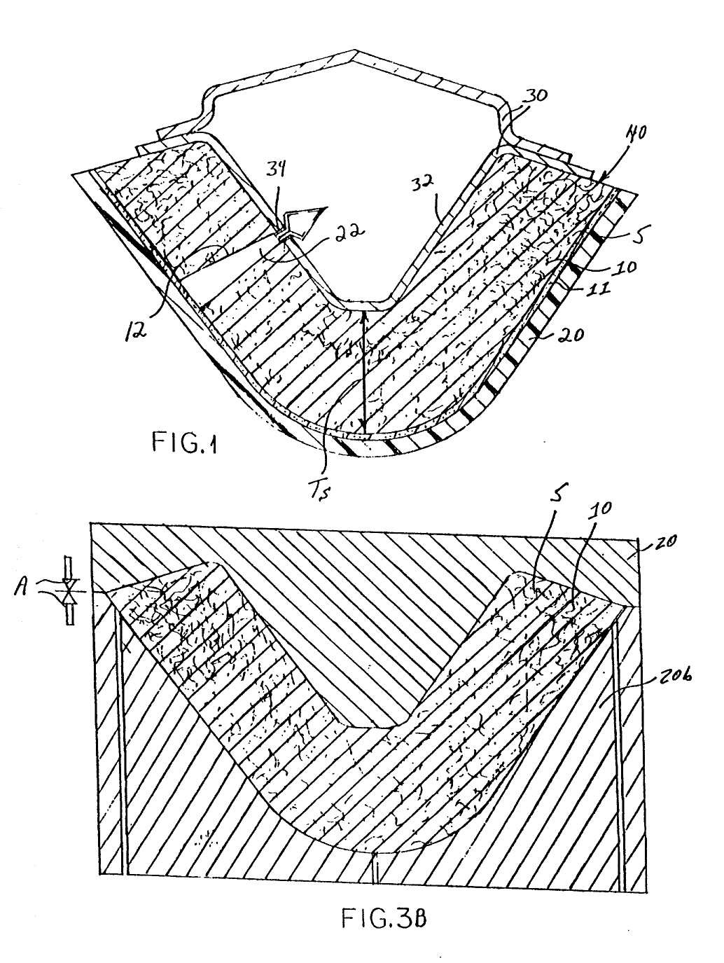

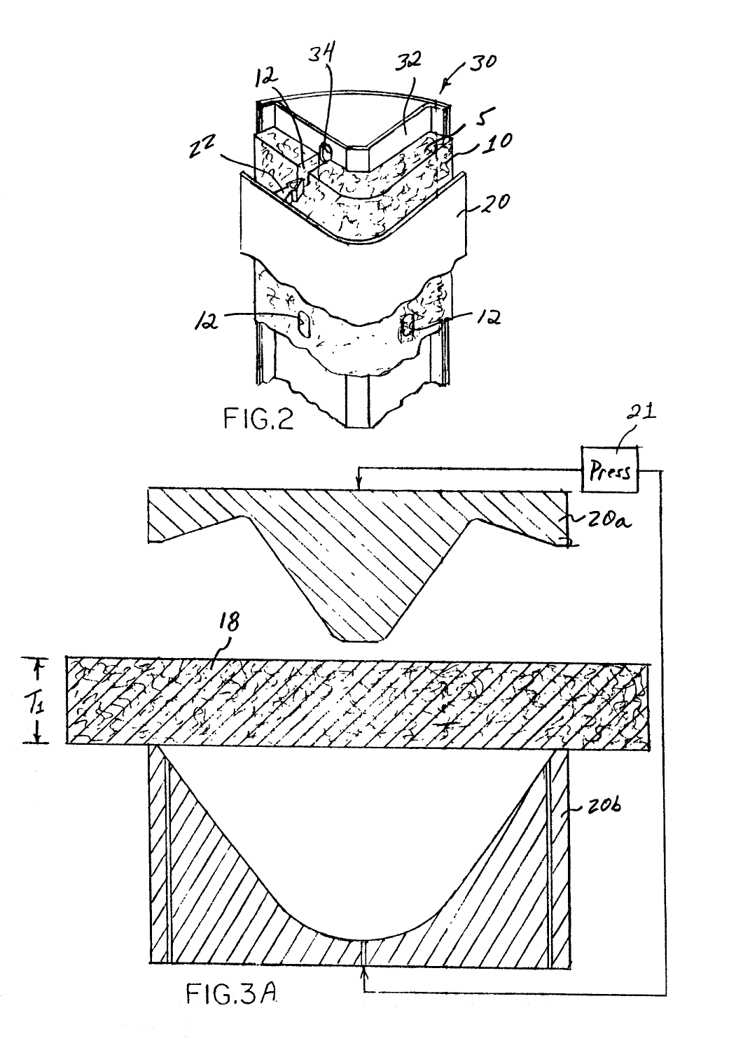

Reference is now made to FIGS. 1 and 2, which illustrate an impact absorbing element 5, a sheath 10 in the illustrated embodiment, and a corresponding trim panel 20, constructed in accordance with the present invention, both coupled to a vehicle pillar 30, an A-pillar in the illustrated embodiment. The pillar 30 has a contoured first surface 32 facing toward the interior of the vehicle and may have a plurality of apertures 34 (one is shown in FIGS. 1 and 2). The trim panel 20 is coupled to the pillar 30 in the illustrated embodiment via a plurality of snap-fit connectors 22 (one shown), which are received in corresponding apertures 34 in the pillar 30. Conventional locator pins (not shown) on the trim panel 20 and conventional clips (not shown) which further couple the trim panel 20 to the pillar 30 may also be provided. A plurality of openings 12 is provided in the sheath 10 through which the trim panel connectors 22 extend. An elongated cavity 40 is defined between the trim panel 20 and the pillar 30 along the length of the pillar 30. The sheath 10 is molded to fit securely between the trim panel 20 and the pillar 30. Preferably, the sheath 10 completely fills the cavity 40 and extends substantially the entire or nearly the entire length of the pillar 30.

The trim panel 20 is formed, such as by injection molding, from a polymeric material such as polypropylene, acrylonitrile-butadiene styrene terpolymer (ABS) or a like material. The trim panel 20 may be coupled to the sheath 10 by an adhesive 11; examples include a 1- or 2-part epoxy, a 2-part urethane, one of which is commercially available from 3M Corporation under the trade designation “Scoth Weld 2214,” and another of which is commercially available from Essex Chemicals under the product designation “Betamate 73553.” During assembly, the trim panel connectors 22 are aligned with and inserted through the sheath openings 12 as the trim panel 20 is adhesively secured to the sheath 10. The connectors 22 are later snap-fit into the apertures 34 in the pillar 30, so as to couple the trim panel 20 and sheath 10 to the pillar 30. In addition to securing the sheath 10 in position against the pillar 30, the trim panel 20 further functions to provide an aesthetically pleasing interior appearance. It is not necessary that the sheath 10 be adhesively coupled to the trim panel 20. Instead, the sheath 10 may be mechanically held in place against the pillar 30 by the panel 20 and its connectors 22.

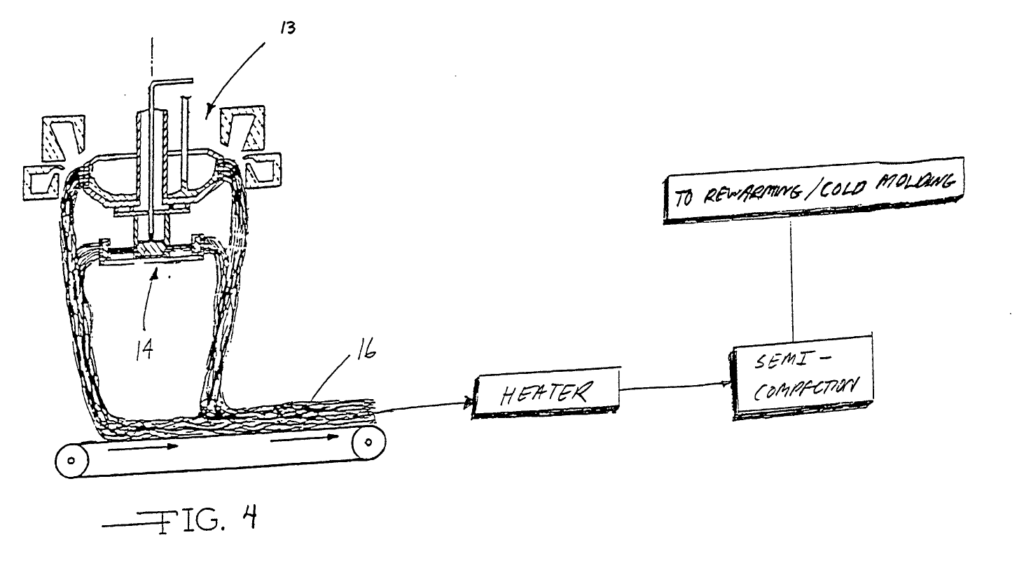

As shown in FIG. 4, the material used to form the sheath 10 is a composite comprised of both mineral fibers, such as glass fibers (such as A glass with a small amount (less than 1-3% by weight) of a sizing, primarily, so as to keep the fibers from abrading and damaging one another during processing), and organic fibers, such as polymeric fibers. The polymeric fibers may be formed from any one of the following polymeric materials: polypropylene; polyphenylene sulfide; polyethylene terephthalate (PET); polyethylene; poly(α-olefin) copolymers; nylon 6; nylon 66; nylon 46; nylon 12; copolyamides; polycarbonate; copolymers of polycarbonate; polybutylene terephthalate (PBT); polypropylene terephthalate (PPT); polyphenylene ether (PPE); water soluble polymers; any other organic material capable of being fiberized; and blends thereof. The mineral and organic fibers may be formed by a number of processes, as noted below, one of which involves the use of separate centrifugal spinners 13, 14 that create the fibers and allow them to mix or entangle to create a co-fiberized material. A detailed description of the overall process for this manner of forming a co-fiberized material is found in commonly assigned U.S. Pat. Nos. 5,523,031 and 5,523,032, both to Ault et al., the disclosures of which are wholly incorporated herein by reference. Descriptions of similar co-fiberizing processes and the co-fiberized materials formed thereby that may be useful in forming the sheath 10 according to the teachings of the present specification may also be found in commonly assigned U.S. Pat. Nos. 6,113,818; 5,900,206; 5,876,529; 5,490,961; 5,468,546; and 5,458,822, the disclosures of all of which are incorporated herein by reference.

As a result of this co-fiberizing process, and as illustrated in FIG. 4, a lofted batt 16 of a composite fibrous (mineral/organic fiber) material is formed. This lofted batt 16 may have a thickness of from about 2 inches to about 36 inches and preferably about 12 inches, but this range may vary depending on the co-fiberizing process parameters (the diameter of the apertures in the spinners, the temperature and viscosity of the starting materials, the rotational velocities of the spinners, etc.). The batt 16 may comprise mineral fibers in an amount from about 10% to about 90% by weight, based on the total weight of the batt 16, and organic fibers in an amount from about 10% to about 90% by weight, based on the total weight of the batt 16. The mineral fibers preferably have a diameter of from about 3 microns to about 30 microns and a length of from about 1 inch to about 3 feet. The organic fibers preferably have a diameter of from about 5 microns to about 20 microns and a length of from about 1 inch to about 5 feet.

After creation, but prior to use in forming a sheath 10 or other impact-absorbing element, the lofted batt 16 is usually heated in an oven (not shown), if necessary to keep it pliable. While in a pliable or soft state, the batt 16 is then compacted into a thinner, but still somewhat lofted (semi-compacted) substrate 18, see FIG. 3A. This moderate compaction may be accomplished by passing the batt 16 between a pair of opposing, spaced-apart endless conveyor belts (not shown). In one embodiment, this initial semi-compaction step creates a layer or substrate 18 having a substantially constant thickness T, of between about 0.5 inch and about 2 inches, see FIG. 3A, and a density of from about 500 grams/m² to about 3000 grams/m². This resulting semi-compacted layer of material 18 may then be stored for later use, or forwarded for further immediate in-line processing, as outlined in the description that follows.

In accordance with the present invention, the substrate 18 is compressed or molding via a conventional compression or molding process. In the case where the layer or substrate 18 is allowed to cool after being semi-compacted, it is first necessary to heat the semi-compacted substrate 18 to a temperature of from about 300 degrees F. to about 400 degrees F. to make it soft, pliable and otherwise capable of being molded, i.e., deformed. This can be done by passing the substrate 18 through a warning device, such as an infrared or convection oven (not shown). The heated substrate 18 is then placed between cold opposing dies 20a, 20b in a molding press 21. These dies 20a, 20b are capable of moving relative to each other between open (FIG. 3A) and closed (FIG. 3B) positions, see action arrows A.

In the illustrated embodiment, the dies 20a, 20b each have corresponding surface contours, and each is coupled to the press 21, which may comprise a conventional hydraulic or pneumatic press or a like motive device capable of moving the dies towards and away from one another. When brought together, the stationary layer or substrate 18 is thus compressed and molded so as to form a sheath 10 that preferably has a shape so as to substantially fill the cavity 40 defined between the trim panel 20 and the pillar 30. The sheath may have a maximum thickness T_{S} of between about 5 mm and about 50 mm, see FIG. 1, and a density of from about 500 grams/m² to about 3000 grams/m². It is also contemplated that two or more layers or substrates 18 may be combined to form an energy-absorbing element of a desired thickness.

The invention will now be described by way of the following non-limiting example.

### EXAMPLE

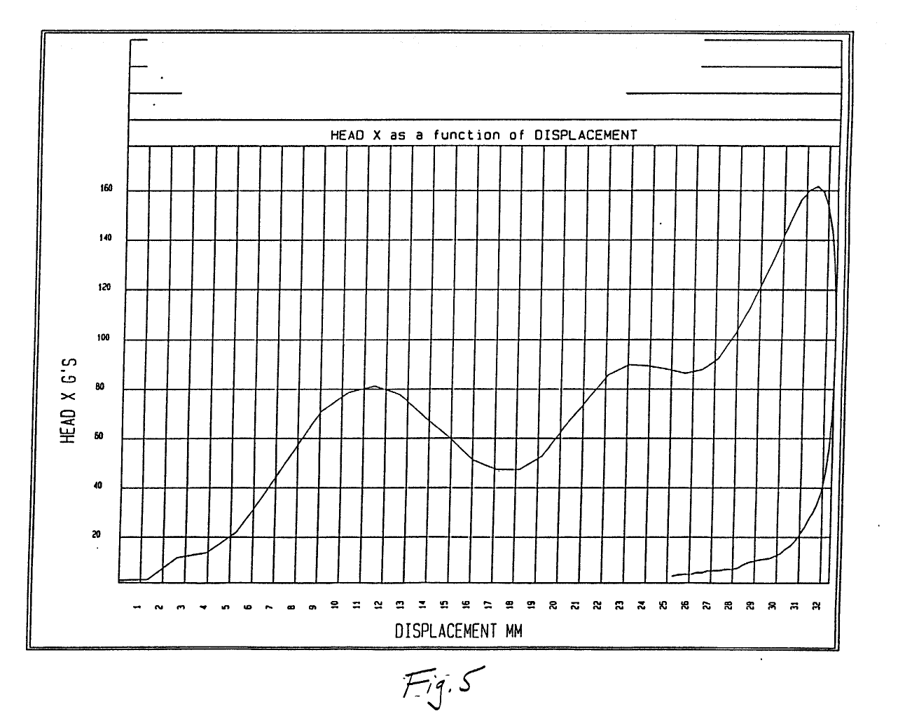

A sheath was formed from a co-fiberized composite material comprising glass fibers in an amount of 60% by weight, based on the total weight of the composite material, and polypropylene fibers in an amount of 40% by weight, based on the total weight of the composite material. The sheath had a final density of 2000 grams/m² and the final thickness was about 20 mm. An accompanying trim panel was formed to match the contour of the A-Pillar sheet metal structure. The material used for the trim panel or application was a standard automotive interior trim grade polypropylene and had a thickness of about 0.125 inch. The sheath and trim panel were subjected to free motion head form (FMH) impact by a hybrid III dummy moving at a velocity of approximately fifteen miles per hour in accordance with a test defined by Federal Motor Vehicle Safety Standard 201U. An acceleration based injury index value, referred to as a “HICd” value, should be less than 1000 in order to successfully pass this test. Testing of this sheath/trim panel combination yielded a HICd value of 697. Behavior of the sheath/trim panel under the influence of the load applied to it by the hybrid III dummy is illustrated by the curve set out in FIG. 5, which shows dummy head acceleration vs. the displacement of the sheath/trim panel by the dummy head.

Obvious modifications are also possible in light of the teachings provided above. For instance, it is possible to form or mold the energy absorbing element of the present invention as a lofted section in a headliner or to a shape conforming to that of another vehicle component, such as that of other vehicle pillars, e.g., B, C or D pillars, so that the element may absorb at least a portion of impact energy resulting from the vehicle's driver and/or a passenger being forced into contact with the element and vehicle component during a crash.

The foregoing description of the present invention has been presented for purposes of illustration and description. It is not intended to be exhaustive or to limit the invention to the precise form disclosed. Obvious modifications or variations are possible in light of the above teachings. The embodiments described were chosen to provide a general illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An energy-absorbing element capable of absorbing a portion of impact energy created during a collision, the energy-absorbing element comprising at least one layer of composite material comprising a mixture of mineral fibers and organic fibers.

2. An energy absorbing element as set forth in claim 1, wherein said composite material comprises a co-fiberized composite material.

3. An energy absorbing element as set forth in claim 2, wherein said mineral fibers comprise glass fibers.

4. An energy absorbing element as set forth in claim 3, where said organic fibers are formed from a material selected from the group consisting of polypropylene; polyphenylene sulfide; polyethylene terephthalate (PET); polyethylene; poly(α-olefin) copolymers; nylon 6; nylon 66; nylon 46; nylon 12; copolyamides; polycarbonate; copolymers of polycarbonate; polybutylene terephthalate (PBT); polypropylene terephthalate (PPT); polyphenylene ether (PPE); and blends thereof.

5. An energy absorbing element as set forth in claim 1, wherein said layer has a maximum thickness of from about 5 mm to about 50 mm.

6. An energy absorbing element as set forth in claim 5, wherein said layer has a density of from about 500 grams/m² to about 3000 grams/m².

7. An energy absorbing element as set forth in claim 6, wherein said layer comprises a sheath having a generally U- or V-shape and is adapted to be positioned adjacent to a vehicle pillar.

8. An energy absorbing element as set forth in claim 1, wherein the composite material comprises mineral fibers in an amount from about 10% to about 90% by weight, based on the total weight of the composite material, and organic fibers in an amount from about 10% to about 90% by weight, based on the total weight of the composite material.

9. A method of manufacturing an energy absorbing sheath adapted to be positioned adjacent to a vehicle pillar, comprising:
providing a composite material substrate comprising a mixture of mineral fibers and organic fibers; and
forming the composite material substrate into the sheath.

10. The method according to claim 9, wherein the forming step includes placing the substrate between a pair of opposing dies that together form an inner cavity when closed corresponding to the desired shape of the sheath.

11. The method according to claim 9, wherein the substrate is formed into a substantially U- or V-shaped sheath.

12. The method of claim 9, wherein the sheath has a density of from about 500 grams/m² to about 3000 grams/m².

13. A trim panel/sheath combination adapted to be secured to a vehicle pillar comprising:
a polymeric trim panel; and
a sheath formed of composite material comprising a mixture of mineral fibers and organic fibers.

14. A trim panel/sheath combination as set forth in claim 13, wherein said composite material comprises a co-fiberized composite material.

15. A trim panel/sheath combination as set forth in claim 14, wherein said mineral fibers comprise glass fibers.

16. A trim panel/sheath combination as set forth in claim 15, wherein said organic fibers are formed from a material selected from the group consisting of polypropylene; polyphenylene sulfide; polyethylene terephthalate (PET); polyethylene; poly(α-olefin) copolymers; nylon 6; nylon 66; nylon 46; nylon 12; copolyamides; polycarbonate, copolymers of polycarbonate; polybutylene terephthalate (PBT); polypropylene terephthalate (PPT); polyphenylene ether (PPE); and blends thereof.

17. A trim panel/sheath combination as set forth in claim 13, wherein said sheath has a maximum thickness of from about 5 mm to about 50 mm.

18. A trim panel/sheath combination as set forth in claim 17, wherein said sheath has a density of from about 500 grams/m² to about 3000 grams/m².

19. A trim panel/sheath combination as set forth in claim 18, wherein said sheath has a generally U- or V-shape and is adapted to be positioned between the pillar and the trim panel.

20. A trim panel/sheath combination as set forth in claim 13, wherein the composite material comprises mineral fibers in an amount from about 10% to about 90% by weight, based on the total weight of the composite material, and organic fibers in an amount from about 10% to about 90% by weight, based on the total weight of the composite material.

21. A trim panel/sheath combination as set forth in claim 13, wherein said trim panel has density of from about 0.5 grams/cm³ to about 1.5 grams/cm³.
